(19) United States
(12) Patent Application Publication
(10) Pub. No.: US 2015/0220755 A1
(43) Pub. Date: Aug. 6, 2015

(54) SOLUTION FOR SECURITY, SAFE AND TIME INTEGRITY COMMUNICATIONS IN AUTOMOTIVE ENVIRONMENTS

(71) Applicant: INFINEON TECHNOLOGIES AG, Neubiberg (DE)

(72) Inventors: Albrecht Mayer, Deisenhofen (DE); Rafael Zalman, Markt Schwaben (DE)

(21) Appl. No.: 14/597,860

(22) Filed: Jan. 15, 2015

(30) Foreign Application Priority Data
Jan. 31, 2014 (DE) 10 2014 001 270.0

(51) Int. Cl. G06F 21/62; G06F 13/42

(52) U.S. Cl. CPC G06F 21/6218; G06F 13/4221

(57) ABSTRACT

A method is disclosed for transmitting user data, wherein a first codeword is initially calculated using a transmit-side time value. The user data are then transmitted together with the first codeword to a receiver. The method continues with the calculation of a second codeword using a receive-side time value. If the first codeword and the calculated second codeword do not match one another, the user data are marked in the receiver.

### FIELD OF THE INVENTION

The invention relates to a method, a transmitter, a receiver and a system for protected data transmission, in particular for automobile applications.

### BACKGROUND TO THE INVENTION

Modern automobiles have a multiplicity of different electrical components. The data to be transmitted between these components are normally present in digital form. The data transmission is controlled and monitored by microcontrollers. The digital data may, for example, be digitized measurement values acquired by sensors or may represent control data for engine management.

The data to be transmitted are normally transported via bus systems from a transmitter to one or more receivers which network the different components or systems in an automobile with one another. The CAN bus (Controller Area Network), for example, or TTCAN bus (Time Triggered CAN), LIN bus (Local Interconnect Network), Ethernet or FlexRay bus are used as the transport medium.

The secure transmission of these data is of great importance, particularly if the control of safety-related systems such as e.g. airbags or automatic braking systems is involved. In addition, the data transmitted between the different systems must be protected against unauthorized access. Hackers could try to influence the data traffic via a bus in an impermissible manner.

In the case of an automobile, an example of a malicious attack by a hacker could consist in interfering with the internal bus system of the vehicle and corrupting the data to be transmitted. Rather than modifying the data themselves, an attack could also consist in interrupting or delaying the data traffic on the bus system, or recording said data for later purposes.

International patent application WO 2013/128317 shows a method and a system for measures against a repeated transmission of recorded messages in the case of a CAN bus through the use of counting values. These counting values indicate the number of previously transmitted messages.

The object of the present invention is to provide a method and a system with which a high degree of data security is achieved in data transmission in automobiles.

### SUMMARY OF THE INVENTION

A method is disclosed for transmitting user data, wherein a first codeword is initially calculated using a transmit-side time value. The user data are then transmitted together with the first codeword to a receiver. The method continues with the calculation of a second codeword using a receive-side time value. If the first codeword and the calculated second codeword do not match one another, the user data are marked in the receiver.

### BRIEF DESCRIPTION OF THE DRAWINGS

FIG. 1 shows a date frame with two blocks.

FIG. 2a shows a transmission system with a transmitter, a bus and a receiver.

FIG. 2b shows time units with allocated time values which have a length corresponding to the maximum resolution of a first internal timer.

FIG. 2c shows time units with allocated time values which have a shorter length than the maximum resolution of an internal timer.

FIG. 3 shows an example embodiment of a transmission system in which a transmit-side time value is processed in an MAC.

FIG. 4 shows an example embodiment of a method for protected data transmission.

### DETAILED DESCRIPTION

The following detailed description refers to the attached drawings, which form a part of the disclosure of the invention and in which specific example embodiments are presented for illustration, by means of which, by way of example, the invention can be implemented in practice. Other example embodiments can obviously be used and structural or other modifications can be made without departing from the protective scope of the present invention. The following detailed description is therefore not to be understood in a limiting manner. Instead, the protective scope of the present invention is defined only by the accompanying patent claims.

A protective mechanism against the described type of “time attacks” consists in providing the data to be transmitted with a “timestamp”. A datum is a valid datum for a receiver only if a predefined time period has not yet elapsed since the dispatch of the datum. In order to protect against attacks, the data transmitted by a transmitter via a bus are therefore provided with time information which allows the receiver to determine whether the received data are still valid or not.

The transmission of user data present in digital form from a transmitter to a receiver is, for example, undertaken using data frames which, in addition to the user data, contain further data which serve, inter alia, to detect and/or correct faults during the transmission. These further data are generated by encoders which, on the basis of the input data fed to them, generate codewords in order to indicate erroneous transmissions and therefore protect the user data. The described time information, which effectively protects against the described type of attacks, can then be integrated into the calculation of the codewords.

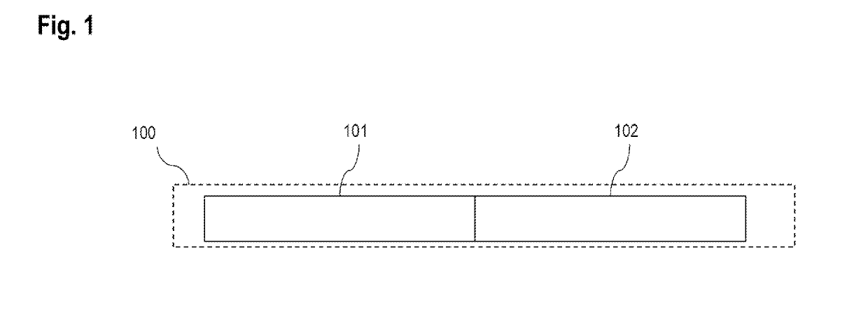

FIG. 1 shows a data frame 100 which contains a first block 101 and a second block 102. The block 101 may contain, for example, user data (“payload”) representing, for example, control data for an electronic component in the automobile and are transmitted via a CAN bus (not shown in FIG. 1). In a further example, in addition to the user data or message, the first block 101 also contains time information in the form of a digital time value. This transmit-side time value defines an expiration period for the message and can be appended or prefixed to the user data. Thus, for example, a time value of “0000 1111” can be incorporated as an 8-bit word into the first block 101.

Block 102 contains, for example, a first codeword which is used for transmission security in the transfer of the user data to a receiver. In one embodiment, it is a single parity bit. The codeword in block 102 may also comprise a plurality of bits and may represent redundant information for the user data. The codeword can be calculated in block 102 e.g. using a Hamming code or cyclic redundancy code (CRC) on the basis of the user data, wherein the calculation of the codeword is based on a polynomial division.

The codeword in block 102 may also be a signature which is determined, for example, by means of a coding algorithm using the user data present in block 101. Thus, for example, block 102 may comprise an MAC (Message Authentication Code). The MAC is formed in further examples using user data and a time value or using a time value only, wherein the time value is generated in each case, for example, in a transmitter and defines a valid time period for the user data or message.

If the MAC is formed using the time value only, this has the advantage that the MAC calculation unit can calculate a list of MACs in advance on the transmitter side and the receiver side. The MAC calculation unit can thus be used efficiently and the MAC calculation is, in particular, no longer in the real-time path between the valid user data and the start of the transmission (in the transmitter) or the received user data and the completed check (in the receiver). This precalculation would also be possible if the MAC calculation were not based on the time value but on a different known number sequence, e.g. a counter value for the transmitted useful data blocks.

Examples of the calculation of an MAC known to the person skilled in the art are, in particular, CMACs (cipher based MACs) or HMACs (hash function based MACs). A CMAC is based on a symmetric key code such as, for example, AES (Advanced Encryption Services). Further examples of an MAC are MD5 (Message Digest 5) or SHAl (Secure Hash Algorithm). The codeword in block 102 may also comprise a combination of a plurality of codes, such as, for example, an MAC and a CRC.

With the data frame 100, along with the user data in block 101, a codeword is thus present in block 102 which is defined, for example, via an implicitly contained time value, an expiration period or a valid time period of the user data.

The data frame may contain further blocks which are transmitted to the receiver. A further protective measure for the user data may consist in generating a cyclic block code. This is generated, for example, via a shift register logic and may be a CRC (Cyclic Redundancy Check) code. The block code is transmitted as part of the data frame.

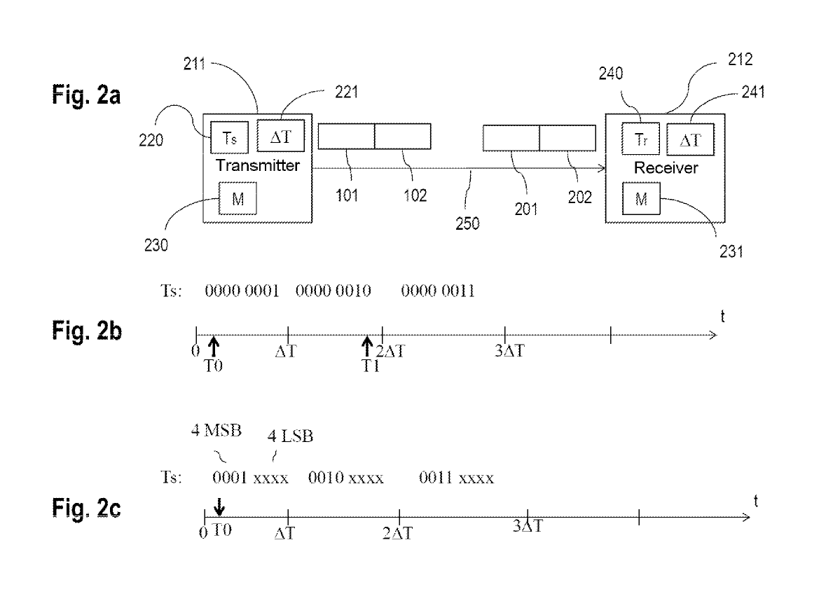

FIG. 2a shows an example embodiment with a transmitter 211 and a receiver 212 which are connected via a bus 250. The transmitter 211 and the receiver 212 are, for example, network nodes in a CAN (Controller Area Network) based transmission system. The bus 250 may correspondingly be a CAN bus or a TTCAN (Time Triggered CAN) bus. In a further example embodiment, the bus may also be an LIN (Local Interconnect Network) bus, Ethernet or a FlexRay bus.

The transmitter 211 generates a data frame which contains a first block 101 and a second block 102. Block 101 comprises e.g. the message 230. Block 102 comprises a first codeword which is formed by encoding a first data set. The first data set may contain both the user data and the transmit-side time value Ts, or the time value Ts only. If only the time value Ts is used, the protection of the user data can be implemented via other measures. These measures include, for example, the calculation of a further codeword, e.g. a CRC, in the calculation of which the codeword and the user data are used. This further codeword is then appended, in addition to or instead of the first codeword, to the data frame which is transmitted to the receiver.

The first data set may comprise a combination of the message 230 and the transmit-side time value 220. In one embodiment, the first data set may also comprise the transmit-side time value 220 only. The data frame generated by the transmitter 211 therefore contains not only the message 230 or user data in block 101, but also time information relating to the validity of the user data which is contained in encoded form in the second block 102.

The transmitter 211 generates a message (M) or the user data 230 and a transmit-side time value (Ts) 220 which is uniquely linked to the message. The transmit-side time value 220 (Ts) can be generated in the transmitter 211 by reading off the time of an internal timer (not shown), e.g. a clock, at defined intervals. According to the selected time intervals, the time value 220 (Ts) thus describes a time period which defines the validity of the message with its allocation to the message.

The shortest time interval which enables the generation of different time values Ts is therefore defined by the smallest temporal resolution of the timer. In this case, the resolution of the timer corresponds to the length of the time value 220 (Ts). The length of the time value is defined by the number of bits used to represent the time value. The time value can thus be represented, for example, by 8 bits, 16 bits, 32 bits, 64 bits, 128 bits, 256 bits or 512 bits.

As shown in FIG. 2b, the transmitter 211 may, for example, link a message M to a time value of Ts=0000 0001, if the message is generated between t=0 and t=ΔT. For example, a message may be generated in the transmitter at the time T0, and the basic time ΔT may, for example, be one millisecond. If a message is generated in the time interval from ΔT to 2ΔT, a time value modified by one counting unit, i.e. Ts=0000 0010, is allocated to the message.

A counting unit is the value by which the transmit-side time value is modified if a modified time value is to be allocated to a message M on expiration of a defined basic time ΔT.

The maximum number of differentiable time values is defined by the length of the time value. Using the full resolution of an internal clock (not shown) of 8 bits or a length of the time value of 8 bits, a maximum of 256 time values, for example, are differentiable. In practice, a multiple of 8 bits is used as the length of the time value.

FIG. 2c shows a further example embodiment of the structure of a transmitter-side time value 220. In this case, in contrast to the representation in FIG. 2b, the full resolution of an internal clock is not used. In this example, although an internal clock has a resolution of 8 bits, the time value Ts has a length of 4 bits only, i.e. the 4 LSBs (Least Significant Bits) of the “clock” are ignored in the later validity check on the receive side. In generating a message in the interval between 0 and ΔT, a time value Ts=0001 is thus allocated to this message.

However, if a message is generated in the following time interval between ΔT and 2ΔT, a time value modified by one counting unit is again allocated to the message, wherein the counting unit is related to the LSB of the time value. In generating a message in the interval between ΔT and 2ΔT, a time value Ts=0010 is thus allocated to the message. In this case also, the number of differentiable time values is defined by the length of the time value or the used resolution of an internal clock present in the transmitter.

The algorithm used for coding may be an algorithm for calculating an MAC, such as e.g. a CMACs (cipher based MACs) or HMACs (hash function based MACs). Further examples of an MAC are MD5 (Message Digest 5) or SHAl (Secure Hash Algorithm). The codeword which is contained in block 102 may also be a combination of a plurality of codes, such as, for example, the combination of an MAC and a CRC.

The receiver 212 receives a first block 201 and a second block 202 via the bus 250. If no changes have been made to the contents of the transmitted blocks 101 and 102 during the transmission, blocks 101 and 201 or 102 and 202 are identical. The receiver 212 extracts from the received block 201 the user data 231 which, in the case of fault-free transmission, are identical to the transmitted user data 230. From the second block 202, the receiver 212 extracts a codeword which, in the case of fault-free transmission, is identical to the first codeword which the transmitter 211 has generated.

So that the receiver 212 can decide whether the received message 231 is still valid and, for example, still lies within the time window in which the message M was generated, a second codeword representing a control signature for the received codeword 202 is generated using a dedicated receive-side time value (Tr) 240 by means of an encoder. The encoder used by the receiver 212 to generate the second codeword uses the same algorithm as the transmitter 211, i.e. if, for example, the transmitter 211 has used a CMAC to generate the first codeword, the receiver 212 likewise uses a CMAC.

A second codeword is calculated on the receive side to check the received first codeword using a second data set. The data used for the second data set correspond structurally to the used data of the first data set on the transmit side, i.e. the second data set may contain both the received user data and a receive-side time value Tr, or may contain a receive-side time value T only.

The receive-side time value Tr is synchronized with the transmit-side time value Ts. In one embodiment, Ts and Tr match one another. In a further embodiment, Tr is reduced by one or more counting units.

The receiver 212 uses a receive-side time value (Tr) 240. This time value is synchronized with the transmit-side time value (Ts) 220. In order to synchronize the time values Ts and Tr on the transmit side and on the receive side, a transmit-side timer, e.g. a clock, can be synchronized with a receive-side timer, so that both timers or clocks always indicate the same time.

The time value (Tr) 240 can be generated in the receiver 212 by reading off the time of an internal timer, e.g. a clock, at defined intervals. According to the selected time intervals, the time value 240 (Tr) thus describes a time period. The shortest time interval which enables the generation of different time values Tr is therefore defined by the smallest temporal resolution of the time. In this case, the resolution of the timer corresponds to the length of the time value 240 (Tr).

In one embodiment of the transmission system described by FIGS. 2a-2c, a message M is valid only if the transmit-side time value (Ts) 220 and the receive-side time value (Tr) 240 match one another, since the second codeword calculated on the receive side, for the generation of which the receive-side time value 240 was used, then matches the received first codeword, for the generation of which the transmit-side time value 220 was used. However, if an attacker, for example, delays the data traffic in such a way that the two time values 220 and 240 associated with a message are different on the transmit side and on the receive side, the message can be marked at the receiver and, if necessary, can be rejected.

In a further design of this example embodiment, the transmit-side time value (Ts) 220 and the receive-side time value (Tr) are different. If the transmitter 211 has transmitted its data only a short time before the end of the expiration time, e.g. at the time T1 indicated in FIG. 2b, the data may not arrive at the receiver within the time interval ΔT due to the transit delay via a bus. In this case, the receiver 212 would calculate a second codeword which does not match the received first codeword, since the read off transmit-side clock has already been incremented by one counting unit.

According to FIG. 2b, Tr=0000 0011 applies in this case and Ts=0000 0010 has been used for the relevant message. In this case, the relevant message is delayed in arriving at the receiver, wherein the delay is, however, permissible. In this case, the receiver 212 can carry out a second calculation for a further second codeword, in which, instead of the current, receive-side time value (Tr) 240, it then uses a time value which is reduced by one counting unit, i.e. the receiver 212 carries out a second comparison after the second calculation of the second codeword on the basis of a modified receive-side time value. If the received first codeword and the newly calculated second codeword also do not match one another, the message 222 can be marked and rejected. An even longer delay between the transmitter and the receiver can obviously also be tolerated by agreement. In this case, the receiver would correct its time value (Tr) 240 for calculating the second codeword by more than one counting unit.

In a further example of this design, the transmitter 211 signals the late transmission to the receiver 212. In the simplest case, this signaling can be effected through the transmission of the LSB (Least Significant Bit), i.e. the lowest bit of the transmitter time value, which is transferred to the receiver 212 in addition to the user data. In this case, following a reading of the identifier bit, the receiver 212 can directly define its receive-side time value (Tr) 240 for calculating the second codeword without first performing a calculation on the basis of the originally assumed receive-side time value. It is obviously also possible to use more than one bit which, on the one hand, enables greater flexibility, but, on the other hand, increases the complexity and data volume. With the marking using a plurality of bits, a plurality of LSBs of the transmit-side time value 220 can also be transmitted to the receiver 212.

The receiver can perform the calculation of the second codeword multiple times if a certain delay is permitted during the transmission. This will normally be a maximum of a second calculation with a receive-side time value reduced by one counting unit. In further embodiments, modified, receive-side time values can also be used which represent a greater or lesser deviation from the transmit-side time value.

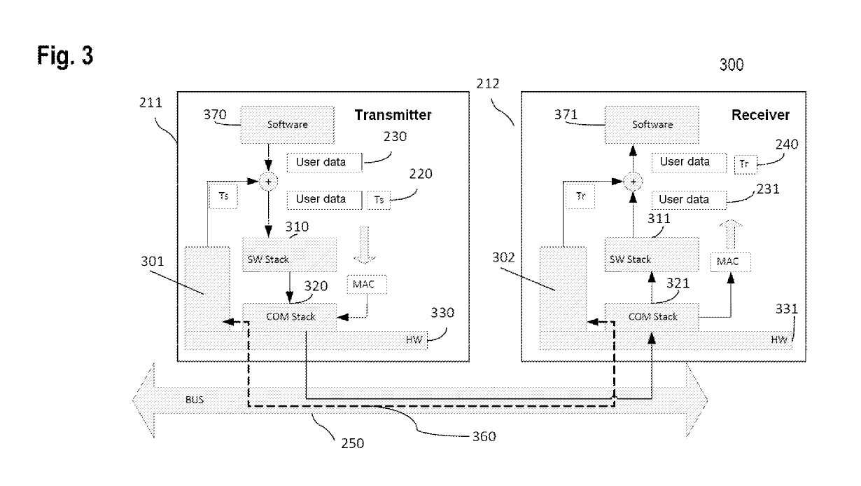

FIG. 3 shows a transmission system 300 with a transmitter 211 and a receiver 221 which are connected via a bus 250. The transmitter 211 comprises a software block 370 which provides the user data 230 to be transmitted and a timer 301 with which the transmit-side time can be defined in the transmitter. In addition, the transmitter 211 comprises the SW stack module 310 and the COM stack module 320.

The software block 370, the SW stack module 310 and the COM stack module 320 may be part of a program which runs on a computing unit and is stored in a memory. The COM stack module 320 is connected via a hardware interface 330 to the bus 250.

Programs which have to meet less-critical safety requirements, for example, can run in the SW stack module 310 and in the COM stack module 320. On the other hand, program code which has to meet special safety-related or critical requirements can run in the software block 370.

The receiver 212 comprises a software block 371 which processes the received user data 231 and a timer 302 with which the receive-side time can be defined in the receiver.

The user data 230 may represent control signals of the type processed by ECUs (Electronic Control Units) in the automobile. In one embodiment, the time value 220 (Ts) generated by the transmit-side timer 301 is fed together with the user data 230 to the software stack module 310 which calculates a first codeword.

In a further embodiment, a first codeword can also be calculated by the COM stack module 320. Further algorithms can be executed in the module 320 using the user data and the MAC or using the MAC only. One example would be the calculation of a CRC code.

The module 310 or the module 320 can use a coding algorithm which generates, for example, an MAC (Message Authentication Code) using the transmit-side time value 220 (Ts), e.g. Ts=0000 0001 applies. The generated MAC and the user data 230 are output via a hardware interface 330 which is connected to the bus 250.

The receive-side timer 302 generates local time information 240 (Tr), wherein the receive-side timer 302 is synchronized via a synchronization path 360 with the transmit-side timer 301 of the transmitter. For the synchronization, for example, the time Ts read off in the transmitter 211 can be transmitted at certain intervals as user data to the receiver 212. The receiver 212 can then adjust its receive-side timer 302, if required, up to a transit delay error determined by the bus transmission.

Via the hardware interface 330 of the transmitter, a data frame (not shown in FIG. 3) is transmitted via the bus 250 to the receiver 212, wherein the data frame contains the user data 230 and, implicitly via a first codeword, validity information allocated to the user data in the form of the transmit-side time value 220 (Ts).

The receiver 212 receives the transmitted data frame via a corresponding receive-side hardware interface 331 and forwards the received data to the COM stack module 321. The COM stack module 321 carries out a processing of the data frame corresponding to the transmit-side COM stack module 320, i.e., for example, the user data and the transmitted first codeword are extracted and any CRC is calculated. In addition, the COM stack module 321 can calculate a second codeword using the receive-side time value 240 (Tr). In one embodiment, the comparison of the received first codeword and the calculated second codeword can be made in the COM stack module 321. In this case, an immediate repetition for the transmission of the data frame from the transmitter 211 can be requested if the comparison of the two codewords indicates that they do not match one another.

In a further example embodiment, the COM stack module 321 transfers the received user data and the calculated second codeword to the SW stack module 311. In this case, the comparison of the first codeword and the second codeword can take place in the SW stack module 311. If the two codewords do not match one another, measures such as a resynchronization of the local time blocks 301 and 302 can be instigated.

In a further example embodiment, the comparison of the two codewords can also be made only in the software block 371 immediately before the user data are used.

The user data 231 and a time value (Tr) 240 are present in the receiver 212 following the processing of the received data frame. In the SW stack module 311, which is formed, for example, by a CPU, a second codeword can then be defined on the receive side using the user data and the time value Tr. The calculation algorithm to be executed in the SW stack module 311 corresponds to the transmit-side calculation algorithm for calculating the first codeword which is, for example, an MAC.

If, for example, the MAC calculated on the receive side differs from the extracted MAC calculated on the transmit side, the message is marked or rejected. This is the case, for example, when the time values Ts and Tr used to calculate the MACs are different, which equates to an expired validity of the user data associated with the time values. A delayed transmission of previously recorded messages is not possible without detection on the receiver side.

In this example embodiment also, it may arise that the transmitter 211 defines a first codeword using the time value 220, shortly before the validity of the user data associated with the time value Ts expires. The receiver 311 can calculate two different second codewords in order to nevertheless enable a valid transmission of the user data. One with the read off time value Tr and a further codeword which is defined with a time value Tr reduced by one time unit.

The first codeword can be generated in different functional units. One example would be the calculation by a hardwired circuit (320). A further possibility is the calculation by a software implementation (310, 370).

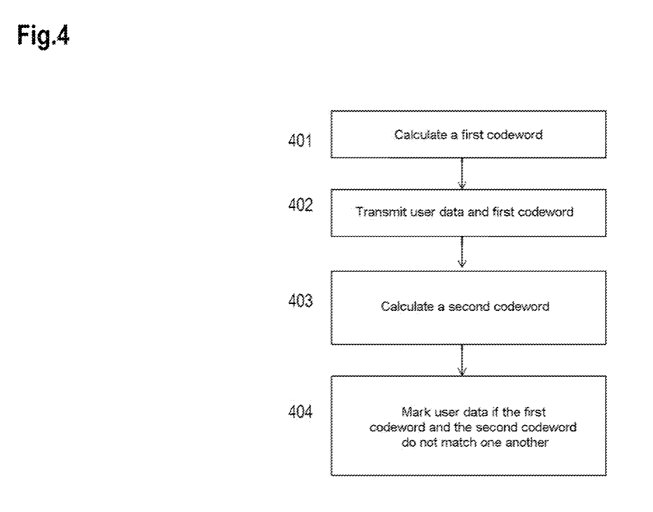

FIG. 4 shows the necessary method steps for protecting user data which are transmitted from a transmitter to a receiver. The method steps can be implemented e.g. on a microprocessor. In step 401, a first codeword is initially calculated, in the calculation of which time information is used with which the time-based validity of the user data is defined. The user data and the first codeword are then transmitted to a receiver in step 402. The calculation of the second codeword then takes place in step 403 on the receiver side, before the user data for which the first codeword and the second codeword do not match one another are marked in step 404.

1. A method for transmitting user data with the following steps:
calculating a first codeword, wherein only a transmit-side time value is used for the calculation;
transmitting the user data and the first codeword to a receiver;
calculating a second codeword, wherein only a receive-side time value is used for the calculation; and
marking the user data if the first codeword and the calculated second codeword do not match one another.

2. The method as claimed in claim 1, wherein the marked user data are rejected.

3. The method as claimed in claim 1, wherein an LSB (Least Significant Bit) or a plurality of LSBs (Least Significant Bits) of the transmit-side time value are additionally transmitted to the receiver.

4. The method as claimed in claim 1, wherein the transmit-side time value is synchronized with the receive-side time value.

5. The method as claimed in claim 4, wherein the transmit-side time value and the receive-side time value match one another.

6. The method as claimed in claim 1, wherein the receive-side time value is reduced by one counting unit or a plurality of counting units compared with the transmit-side time value.

7. The method as claimed in claim 1, wherein the first codeword is an MAC (Message Authentication Code).

8. The method as claimed in claim 1, wherein the transmit-side time value has a length which corresponds to the resolution of a transmit-side timer.

9. The method as claimed in claim 1, wherein the transmit-side time value has a length which is less than the maximum resolution of a transmit-side timer.

10. An apparatus for transmitting a data frame with user data, comprising a first generator configured to generate a first codeword by encoding a first dataset;
a transmitter configured to transmit the data frame which contains the first codeword; and
a second generator configured to generate a time value, wherein the first data set comprises the time value only.

11. The apparatus as claimed in claim 10, wherein the data frame contains the user data and the first codeword.

12. The apparatus as claimed in claim 11, wherein the data frame contains a block code.

13. The apparatus as claimed in claim 10, wherein the first codeword is an MAC (Message Authentication Code).

14. An apparatus for receiving a data frame with user data comprising:
a receiver configured to receive a data frame which contains a first codeword;
a first generator configured to generate a second codeword; and
a second generator configured to generate a time value, wherein the generated second codeword is definable using exclusively the time value.

15. The apparatus as claimed in claim 14, wherein the first generator is configured to define a second codeword using a modified time value.

16. A bus system comprising,
an apparatus for transmitting a data frame via a bus with user data, comprising:
a first generator configured to generate a first codeword by encoding a first dataset;
a transmitter configured to transmit the data frame which contains the first codeword; and
a second generator configured to generate a time value,
wherein the first data set comprises the time value only, and the data frame comprises a message to be transmitted; and
an apparatus for receiving a data frame with user data via the bus comprising:
a receiver configured to receive a data frame which contains a first codeword;
a first generator configured to generate a second codeword; and
a second generator configured to generate a time value,
wherein the generated second codeword is definable using exclusively the time value.

17. The bus system as claimed in claim 16, wherein the transmitter and the receiver are synchronizable via a synchronization path so that a modification of the transmit-side time value determines a change in the receive-side time value.

18. A module with a microprocessor which is configured to calculate a first codeword or a second codeword.
